(19) United States
(12) Patent Application Publication
(10) Pub. No.: US 2010/0329840 A1
(43) Pub. Date: Dec. 30, 2010

(54) FLOW DEFLECTION DEVICE CONSTRUCTION

(76) Inventor: Daniel Farb, Beit Shemesh (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/867,758

(22) PCT Filed: Feb. 12, 2009
(86) PCT No.: PCT/IB09/50578

§ 371 Date: Aug. 16, 2010

Related U.S. Application Data
(60) Provisional application No. 61/028,545, filed on Feb. 14, 2008.
(60) Provisional application No. 61/043,138, filed on Apr. 8, 2008.
(60) Provisional application No. 61/058,235, filed on Jun. 3, 2008.
(60) Provisional application No. 61/089,914, filed on Aug. 19, 2008.

(51) Int. Cl. F03D 11/00

(52) U.S. Cl. 415/2.1; 415/182.1

(57) ABSTRACT

New devices and methods for the construction of large Flow Deflection Devices (FDDs) are presented.

This patent application claims the benefit of U.S. Provisional Patent Application No. 61/028,545, entitled Provisional 2-08: One-directional bearings, Large and Small Wind, Hydro, Blade Design, filed Feb. 14, 2008 and No. 61/043,138, entitled Provisional 4-08 Couplings-FDD-Gears, filed Apr. 8, 2008 and No. 61/058,235, entitled Provisional 6-08: Improvements to renewable energy devices, filed Jun. 3, 2008 and No. 61/089,914, entitled Provisional 8-08: FDDs and Turbines, filed Aug. 19, 2008.

### FIELD AND BACKGROUND OF THE INVENTION

The present invention relates to the construction of large FDDs. The inventor has previously presented the use of large FDDs in association with turbines in patent IL2007/000348 entitled Flow Deflection Devices and Methods for Energy Capture Machines. The current application claims practical aspects and variations of building them with wind and other turbines and in association with a wind farm, and includes more specific designs and claims here.

### BRIEF DESCRIPTION OF THE DRAWINGS

The invention is herein described, by way of example only, with reference to the accompanying drawings, wherein:

FIG. 1 is a diagram of a ¾ FDD made of panels and posts.

FIG. 2 is a diagram of a divided FDD.

FIG. 3 is a diagram of an FDD chassis.

FIG. 4 is a photo of an elevated FDD made of polygonal panels.

FIG. 5 is a photo of an elevating device.

FIG. 6 is a diagram of FDD modules.

FIG. 7 is a diagram of large shapes jutting out from poles.

FIG. 8 is a diagram of innovations attached to the basic FDD structure.

### DESCRIPTION OF THE PREFERRED EMBODIMENTS

The present invention relates to the use of aerodynamic structures to alter flow into turbines.

Definitions: An “FDD” is a device that alters the circulation into a turbine. Unless otherwise specified, in this patent application, it refers to a structure whose axis is perpendicular to the direction of flow and in the plane of the tower and has no functional need to be connected to the turbine or its tower. “Functionally adjacent” means that the FDD of whatever type increases the velocity of the fluid at the blades. The intent of this application is to apply these concepts to wind turbines of 10 meters blade diameter and larger, but the application is not necessarily limited to that size. In this application, the FDD is not required to attach to the wind turbine tower for support.

The principles and operation of the construction of an FDD, particularly for a large wind turbine or wind farm according to the present invention may be better understood with reference to the drawings and the accompanying description.

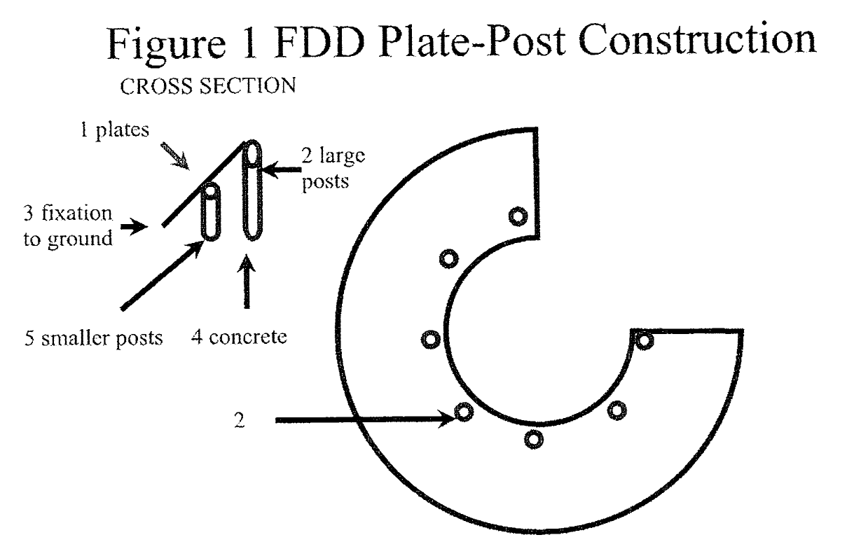

Referring now to the drawings, FIG. 1 illustrates a ¾ FDD made of plates (1) and posts (2). The posts are ideally attached to the ground with concrete (4) at the base. At least a second series of posts (5) can be used. In one embodiment, the plates go all the way to the ground and are attached at that point. There are many options for places of attachment. In one embodiment, the posts are welded to the plates and other structure. In one embodiment, the FDD structure is not a total surround, as in the picture.

One embodiment is that the FDD portion facing the wind is constructed of non-earth materials, in various embodiments metal, plastic, glass, or composites.

The FDD may optionally extend to the ground level. The inclusion of a ground level-attached FDD is specifically introduced here. That can increase the velocity and power at different amounts and levels than when it is above ground level.

We also claim the method of manufacturing and device of the type of construction. Between the earth and the FDD, it may in one embodiment be substantially hollow (4). Support beams (3) will hold up the FDD. The use of support beams with such a structure is hereby introduced. The use of a chassis foundation or a solid or semi-solid interior is also possible.

The following table shows the percentage power output increase where Hg (height of the bottom of the FDD from the ground) is 3 meters or zero in one particular configuration. Hb is height of the blades.

| | | Case 6b |
|---|---|---|
| H_{b} (m) | Case 6b | (Hg = 0) |
| 50 | −8.7 | |
| 60 | 3.9 | 15.2 |
| 70 | 12.8 | 21.9 |
| 75 | 14.6 | 20.7 |
| 80 | 13.3 | 20.8 |
| 85 | 11.7 | 18.6 |

In the ideal embodiment, the base structure is substantially vertical from the ground for a height before it starts to slant towards the turbine. A substantially vertical FDD at the intersection of the FDD with the ground is hereby claimed. An angle of over 45, 50, 55, or 60 degrees from the lower outer corner of the non-vertical portion of the FDD to the inner upper corner is hereby claimed. In addition, the method of using a slope of 45 degrees or more in a climate with snow or ice is presented. To match the embodiment of a wind turbine in a location where the temperature falls below zero degrees centigrade at least one day per year, the angle of the FDD can in one embodiment be greater than 45 degrees, in another 50 degrees, in another 55, in another 60, in another 70. Alternatively, there may be a non-stick or hydrophobic coating on the outer layer.

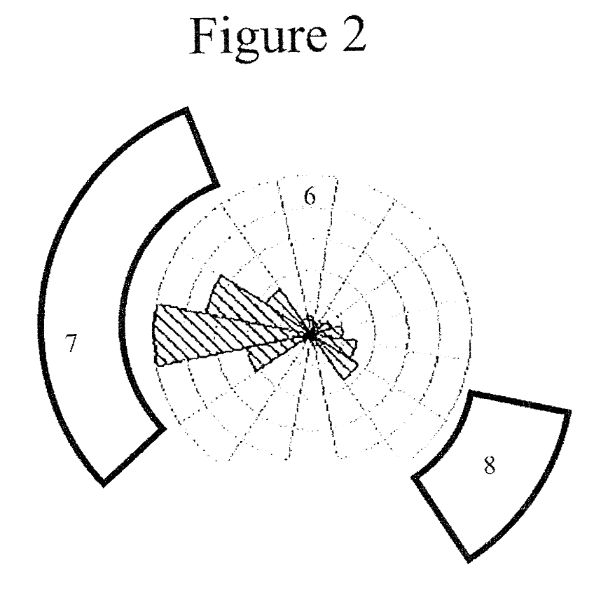

FIG. 2 is a diagram of a divided FDD. In one embodiment, the structure surrounding a large turbine is continuous; in another, it is not. Here it is shown as two separate FDDs (7, 8). The wind tower is in the center, but the picture shows a wind rose (6) superimposed on the area to show the method of arranging the FDDs in the direction of wind so that they have the greatest economic value for the customers.

The FDD is normally constructed as a full or partial doughnut shape, but in other embodiments it can have a varying external radius, internal radius, height, width, and angle of axis for the same FDD in association with a single turbine, or a group of at least two FDDs in association with that same turbine. The FDD may be open on the inside or on the bottom either the whole way, or part of the way.

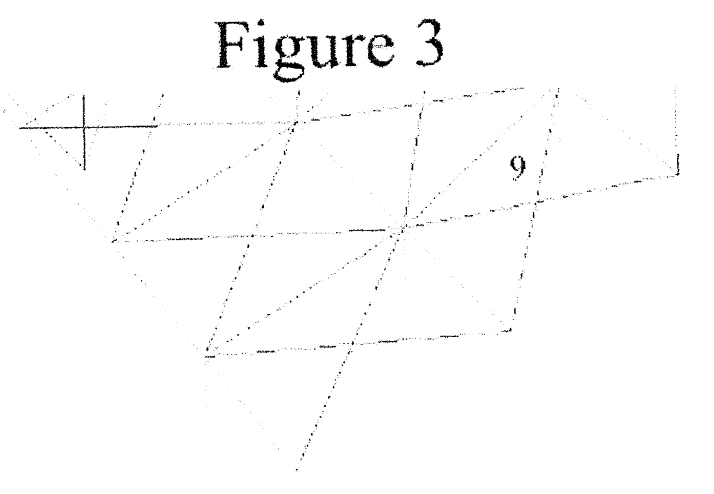

FIG. 3 is a diagram of an FDD chassis (9). A network of pipes or bars can be used instead of, or together with, large posts to hold the FDD in place.

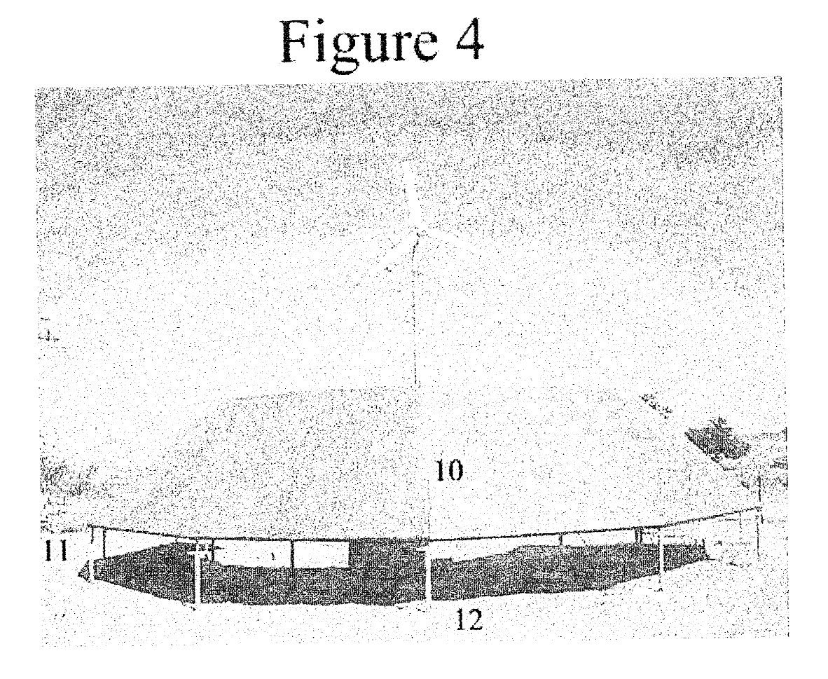

FIG. 4 is a photo of an elevated FDD (10) with a wind turbine in the background. This shows the use of approximation of a cone shape using polygonal panels. Theoretical modeling and actual measurements indicate it performs almost as well as a curved shape. It has in this embodiment steel panels in trapezoidal, shapes. Other materials can be used. It is elevated by posts (11) inserted into concrete bases (12). Such frames could also provide a backbone for a tense structure to fit over it. Constructing the parts of the FDD of modules connected to a device that enables adjustment of the height is one embodiment. Adjustment of height after installation on the ground is hereby claimed in its apparatus, method of manufacture, and method of construction.

The combination of solar panels with the structure, so that it is partially built out of solar panels (or concentrators), is an option. Said solar panels may be curved or flat. Other types of energy production may be integrated.

A gutter may be added to catch rainwater at the bottom of the FDD. After that, there is the option to channel that water through a small turbine.

We introduce here the device of attaching an electrical non-rusting or non-corroding device to the FDD, when the FDD is made of metal.

We introduce here the device of current carriers or wires on the FDD for heating to melt ice or snow, also as a method of manufacture of an FDD and a wind farm.

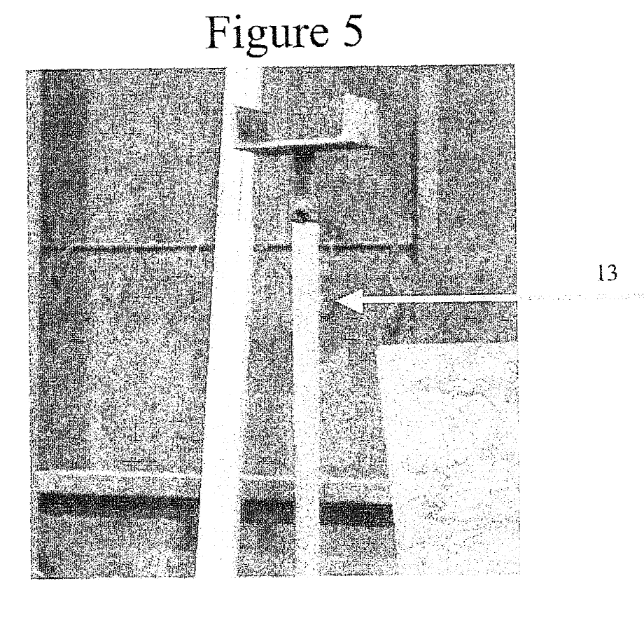

FIG. 5 is a photo of an elevating device for the FDD in FIG. 4. The vertical metal posts (13) can be adjusted vertically by turning a knob that causes sliding of the post touching the panels. The use of an FDD with a turbine can be enhanced by making the structure holding the FDD capable of adjusting the FDD horizontally, vertically, or both.

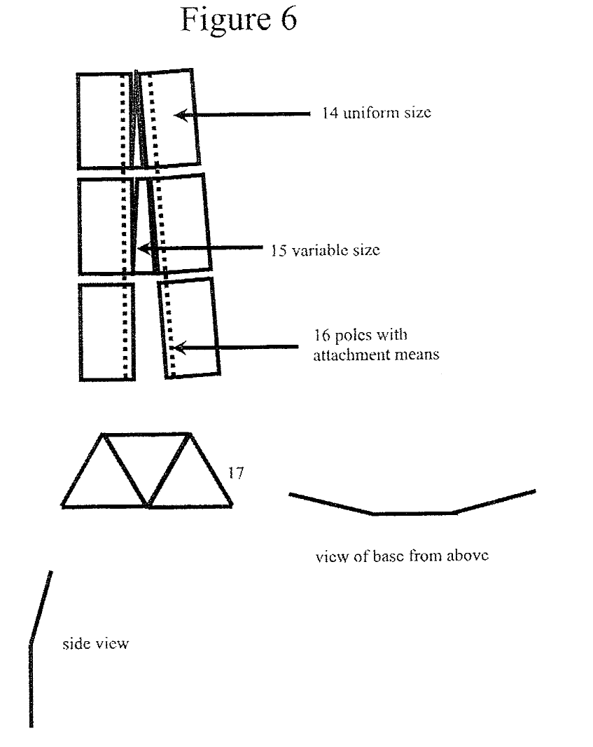

FIG. 6 is a diagram of FDD modules. One approach to building these is to combine smaller modules into the large structure so that a higher proportion of the pieces can be mass-produced. The method of producing modular pieces for at least 50% of the external surface area of the FDD is hereby introduced. Some panels (14) can be modular for any installation, whereas other panels (15) require different shapes for different diameter structures. The poles may have various attachment means (16) for fixating the panels. Another type of polygonal shape that can be used for constructing FDDs is a triangle (17).

Said panels could in various embodiments be of metal such as steel or aluminum, plastic, wood, and earth, and could be both flat and rounded, and the generally round shape could be approximated by using sheet metal construction or other flat panels placed side by side.

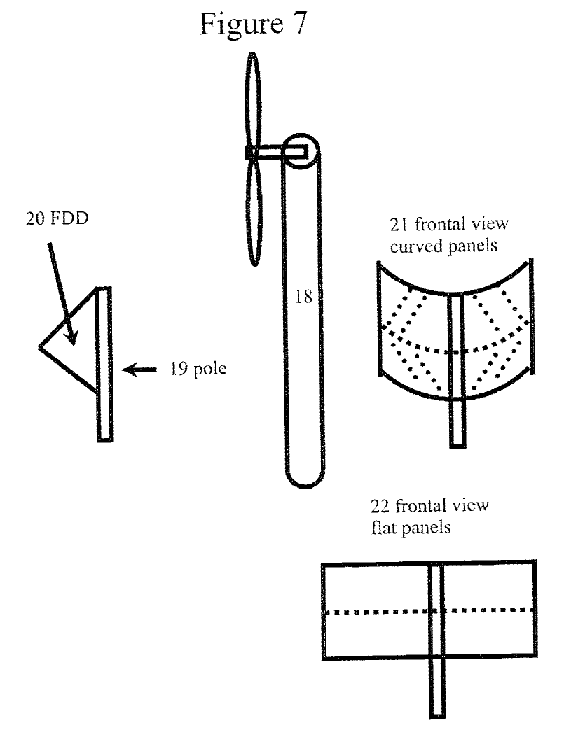

FIG. 7 is a diagram of large shapes jutting out from poles. The wind turbine (18) is in the center. The pole for the FDD (19) holds a portion of a cone shape (20) in the air. The panels held in that way could be curved (21) or flat (22). One type of FDD involves a pole holding a conical shape from which the outer lower triangle (of the conical cross-section) has been cut out, and the lower triangle touches at, or near, the ground in the vicinity of the pole.

In one embodiment of an FDD, the FDD is attached to at least one pole, each pole being mostly interior to the FDD that it holds. In one embodiment, each pole has a concrete base.

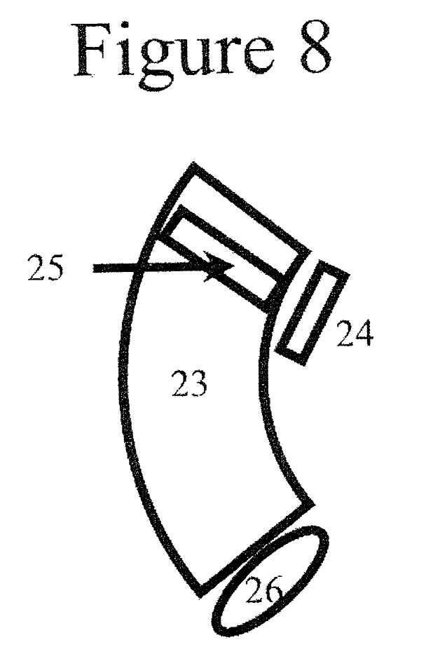

FIG. 8 is a diagram of innovations attached to the basic FDD structure (23). The structure could have movable flaps (24), slats, spoilers, or ailerons attached to any side, most likely the inner diameter, said flaps being controlled to change position with wind or turbine changes. In one embodiment, they are under electronic control. The FDD may have fins (25) to direct the air. These may take the form of corrugations in the FDD itself. In order to decrease turbulence at the edges, a turbulence-reducing means may be added. One example shown is to make a smooth, curved shape (26) at the edges of the FDD. These may move either automatically from the wind or in response to electronic commands. They may change for different wind speeds and directions. The edges of the FDD may have winglets, in one embodiment perpendicular to the earth and in another perpendicular to the FDD at that point. Said winglets may be placed on the interior side of the FDD. The FDD may have small winglets at the edge of an incomplete circle of the FDD doughnut, or winglets in the middle. The winglets may extend above their surroundings by 0.5 meters, 1 meter, 1.5 meters or more, etc., ideally substantially perpendicular to the plane of the FDD.

A large FDD for wind turbines is claimed for use with offshore turbines. It is also claimed as a method of manufacturing an offshore wind farm, whether placing the FDD before the turbine or after the turbine. The FDD can be held in place by a buoy or rig or other system. In another embodiment, the FDD portion starts at an elevation of at least a meter above surface level.

We claim hereby a wind farm, which may have more than one FDD per wind farm.

We introduce here the device of a turbine or wind farm and manufacturing method of a turbine or wind farm for an FDD made of earth. Any change in the landscape greater than 5 meters in any dimension is defined as an alteration for the purpose of altering the flow. In other embodiments, the earth is combined with supports or additional non-earth material including, in different embodiments, metal, plastic, wood, concrete, ice, snow, and stones. The earth, with or without additional material, is used with turbines of greater than 10-meter blade diameters. The method of manufacturing the turbine or wind farm is with the FDD first or second. Any construction in a wind farm that alters the landscape to improve the flow (defined as a piece of construction of earth or other objects that is not functionally required for the operation of the turbine or the access roads or that approximates a foil shape, partial or filled in) is included in the claims noted here.

Normally a wind farm separates the wind turbines by the space of 5 blade diameters, at least by three, in order to prevent them interfering with each other. We introduce the concept of FDDs in association with a wind farm, whose turbines are less than 3 blade diameters apart. The FDDs direct the wind and enable them to be placed closer together. This innovation is claimed both as a device and as a method of manufacturing a wind farm. Constructing a wind farm with turbines whose blade diameters are greater than 10 meters in association with at least one FDD is likewise introduced both as a device and a method of manufacturing.

One method and device of doing that would be a turbulence-reducing FDD. In one embodiment, it would interfere with the turbulence by introducing or causing to occur an out-of-phase wave matching the turbulence. In one embodiment, small holes, riblets, splitter plates, drag reduction coatings, alloys, or channels could decrease the turbulence. In one embodiment, that would be a passive structure. In another embodiment, it would be actively produced.

The use of an FDD can result, when placed accurately, in a fairly uniform distribution of wind velocity across the swept area of the blades. This is particularly important for large turbines, since the wind velocity increases from ground level to the top of the turbine and creates imbalances.

While the invention has been described with respect to a limited number of embodiments, it will be appreciated that many variations, modifications and other applications of the invention may be made.

### SUMMARY OF THE INVENTION

The present invention successfully addresses the shortcomings of the presently known configurations by providing a series of ways of constructing FDDs for wind turbines.

It is now disclosed for the first time an FDD, comprising:

a. at least one panel on its external surface,
b. at least one support beam connected to said panel.

According to another embodiment, the panel is polygonal.

According to another embodiment, a series of said panels approximate a conical shape. (The use of said panels has been found to be a much cheaper approximation of a series of curved shapes with almost the same performance.)

It is now disclosed for the first time an FDD, wherein the external side extends to ground level.

According to another embodiment, the lowest portion of at least 1 meter is substantially vertical.

It is now disclosed for the first time an FDD, comprising: an adjustment device operative to move at least part of the FDD (“part” is defined as including an attachment).

It is now disclosed for the first time an FDD, comprising: an energy production system as part of the construction.

It is now disclosed for the first time an FDD, comprising a second-use structure on the internal side of the FDD. (An example would be a storage area.)

It is now disclosed for the first time an FDD, wherein the FDD is offshore.

It is now disclosed for the first time an FDD, comprising at least one fin (defined as a protruding structure substantially perpendicular to the outer surface of the FDD).

It is now disclosed for the first time a wind turbine system, comprising at least 2 separate FDDs.

It is now disclosed for the first time an FDD, comprising turbulence-reducing means.

According to another embodiment, said means can be any of the following: small holes, riblets, splitter plates, drag reduction coatings, alloys, vortex wave-matching production, winglets, or channels.

It is now disclosed for the first time an FDD for use with a wind turbine in areas where the temperature falls below zero degrees centigrade at least one day per year, wherein the external angle of the FDD is at least 45 degrees, measured from its lowest external point to its highest internal point.

It is now disclosed for the first time an FDD, comprising a hydrophobic coating on its external layer. (This may enable snow and ice to fall off more easily.)

It is now disclosed for the first time an FDD, wherein at least one side edge has a shape different from the rest of the FDD.

It is now disclosed for the first time a method of changing the shape of at least part of the FDD in response to changes in wind parameters.

It is now disclosed for the first time a wind farm, comprising more than one FDD.

It is now disclosed for the first time a wind farm of at least one turbine and one FDD, wherein the FDD at least partially comprises earth

According to another embodiment, the FDD containing earth is at least 5 meters in height

According to another embodiment, the FDD containing earth is used with a turbine of at least 10 meters blade diameter.

It is now disclosed for the first time a method of constructing a wind farm with an alteration of the landscape (defined as a power output-enhancing change of 5 meters or more in any dimension and which may consist of in one embodiment a piece of construction of earth or other objects that is not functionally required for the operation of the turbine or that approximates a foil shape, partial or filled in).

It is now disclosed for the first time a wind farm, comprising:

a. At least one FDD,
b. At least two turbines, said turbines placed less than 3 blade diameters apart in adjacent rows or less than 6 blade diameters apart in alternate rows in relation to the prevailing wind direction.

It is now disclosed for the first time an FDD, comprising: an anti-corrosion device.

It is now disclosed for the first time an FDD for any type of turbine, comprising heating means.

It is now disclosed for the first time a method of placing an FDD in the directions of greatest wind (defined as any section of at least 15 degrees of arc whose wind speed is an average of at least 2 meters per second for at least 5% of the year).

It is now disclosed for the first time a method of constructing an FDD so that the velocity of the wind hitting the swept area of the turbine blades varies in speed by less than one meter per second. (This enables the turbine to sustain less stress on its gears and blades by the correct placement of an FDD.)

1-27. (canceled)

28. An FDD, substantially physically separate from an adjacent turbine, comprising:
a. at least one panel on its external surface,
b. at least one support beam connected to said panel.

29. The FDD of claim 28, wherein the panel is polygonal.

30. The FDD of claim 29, wherein a series of said panels approximate a conical shape.

31. The FDD of claim 28, wherein the FDD is in an axis perpendicular to the wind flow, wherein the external side extends to ground level.

32. The FDD of claim 31, wherein the lowest portion of at least 1 meter is substantially vertical.

33. The FDD of claim 28, further comprising: an adjustment device operative to move at least part of the FDD (“part” is defined as including an attachment).

34. The FDD of claim 28, further comprising a second-use structure on the FDD.

35. The FDD of claim 28 wherein the FDD is offshore.

36. The FDD of claim 28, further comprising at least one fin (defined as a protruding structure substantially perpendicular to the outer surface of the FDD) in an axis perpendicular to the wind flow.

37. The FDD of claim 28, further comprising turbulence-reducing means.

38. The FDD of claim 28, for use with a wind turbine in areas where the temperature falls below zero degrees centigrade at least one day per year, wherein the external angle of the FDD is at least 45 degrees, measured from its lowest external point to its highest internal point.

39. The FDD of claim 28, wherein at least one side edge has a shape different from the rest of the FDD.

40. The FDD of claim 28, wherein the shape of at least part of the FDD changes in response to changes in wind parameters.

41. The FDD of claim 28, wherein the FDD is placed in the directions of greatest wind (defined as any section of at least 15 degrees of arc whose wind speed is an average of at least 2 meters per second for at least 5% of the year).

42. The FDD of claim 28, wherein the FDD is placed so that the velocity of the wind hitting the swept area of the turbine blades varies in speed by less than one meter per second in at least one direction whereby the FDD is upstream from the turbine.

43. The FDD of claim 28, comprising at least partially earth.

44. The FDD of claim 28, further comprising at least 2 separate FDDs.

45. A method of constructing a wind farm with an alteration of the landscape, defined as a power output-enhancing change of 5 meters or more in any dimension and which may consist of in one embodiment a piece of construction of earth or other objects that is not functionally required for the operation of the turbine or that approximates a foil shape, partial or filled in.
